(19) United States
(12) Patent Application Publication
(10) Pub. No.: US 2014/0032670 A1
(43) Pub. Date: Jan. 30, 2014

(54) ACCESS CONTROL IN COMMUNICATION ENVIRONMENTS

(71) Applicant: Google Inc., Mountain View, CA (US)

(72) Inventors: Jeffrey Gordon Ellingson, San Francisco, CA (US); Thunder Parley, San Jose, CA (US); Ronald Ho, Fremont, CA (US); Chad Owen Yoshikawa, Campbell, CA (US); Mayur Kamat, Bothell, WA (US); Robin Elaine Schriebman, Kirkland, WA (US)

(73) Assignee: Google Inc., Mountain View, CA (US)

(21) Appl. No.: 13/953,435

(22) Filed: Jul. 29, 2013

Related U.S. Application Data
(60) Provisional application No. 61/677,431, filed on Jul. 30, 2012.

(51) Int. Cl. H04L 29/06

(52) U.S. Cl. CPC H04L 65/403
USPC 709/204

(57) ABSTRACT

In one aspect, a method includes receiving a request from a user to add one or more users or user groups to a communication session, determining if one or more access rights restrictions are associated with the session, the one or more access rights restrictions defining one or more users or one or more types of users authorized to join the session, determining if the one or more users or user groups are authorized to join the session according to the access rights restrictions when it is determined that one or more access rights restrictions are associated with the session and adding the one or more users or user groups to the session when it is determined that the one or more users or user groups are authorized to join the session. Other aspects can be embodied in corresponding systems and apparatus, including computer program products.

### CROSS-REFERENCE TO RELATED APPLICATION

The present application claims the benefit of U.S. Provisional Patent Application Ser. No. 61/677,431, entitled “Access Control in Communication Environments,” filed on Jul. 30, 2012, which is hereby incorporated by reference in its entirety for all purposes.

### BACKGROUND

Various computer-based communication tools are available that allow users to join in group communication and collaboration. These tools allow users to communicate via video, chat, audio or other means of communication and allow sharing of various objects for communication and collaboration. Any user may initiate a session and invite one or more other users to join the session so that users can communicate with one another.

### SUMMARY

The disclosed subject matter relates to a computer-implemented method including receiving a request from a user to add one or more users or user groups to a communication session. The method further including determining if one or more access rights restrictions are associated with the session, wherein the one or more access rights restrictions define one or more users or one or more types of users authorized to join the communication session. The method further including determining if the one or more users or user groups are authorized to join the communication session according to the access rights restrictions, when it is determined that one or more access rights restrictions are associated with the communication session and adding the one or more users or user groups to the communication session when it is determined that the one or more users or user groups are authorized to join the communication session. Other aspects can be embodied in corresponding systems and apparatus, including computer program products.

These and other aspects can include one or more of the following features. The one or more access rights restrictions may further define one or more operations authorized with respect to each of the one or more users or user groups. The method may further include determining that at least one of the one or more users or user groups is restricted from joining the communication session according to at least one of the one or more access rights restrictions, determining if overwriting the at least one of the one or more access restrictions is allowed and adding the one or more users or user groups as participants of the communication session when it is determined that overwriting the at least one of the one or more access restrictions is allowed. The method may further include adding the one or more users or user groups other than the at least one of the one or more users or user groups restricted from joining the communication session to the communication session when it is determined that overwriting the overwriting the at least one of the one or more access restrictions is not allowed.

The method may further include receiving a request from a first user to add one or more access right restrictions to the communication session, determining if the first user is authorized to add one or more restrictions to the communication session and associating the one or more access rights restrictions with the communication session when it is determined that the first user is authorized to add one or more access rights restrictions to the communication session.

The method may further include receiving a request from a first user to invite a new user to the communication session, determining if the first user is authorized to invite users to the communication session, determining if the new user is authorized to join the session if it is determined that the first user is authorized to invite user to the communication session and inviting the new user to the communication session when it is determined that the first user is authorized to invite user to the communication session.

The one or more access rights restrictions may include one or more access rights restrictions assigned to a one or more communication sessions including the communication session. The one or more communication sessions may be defined based on one or more attributes, and wherein the attributes of the communication session match the one or more attributes defining the one or more communication sessions. The one or more attributes comprise one or more of context information, session attributes, or participant attributes.

The context information comprises one or more of a location where the communication session is initiated, a location from which one or more of the users participate in the communication session, a time when the communication session is initiated or a time where the request is received. The one or more groups of users are defined based on one or more attributes, the attributes including one or more of user attributes, context information or communication session attributes.

The disclosed subject matter also relates to a system including one or more processors; and a machine-readable medium including instructions stored therein, which when executed by the processors, cause the processors to perform operations including receiving a request to add one or more users or user groups to a communication session from a first user. The operations further comprising identifying one or more access rights restrictions corresponding to the communication session, wherein the one or more access rights restrictions comprise a list of one or more users or user groups authorized to join the session and one or more operations authorized with respect to each of the one or more users or user groups. The operations further comprising determining if the first user is authorized to add one or more users to the communication session according to the one or more access rights restrictions. The operations further comprising determining if the one or more users or user groups are authorized to join the communication session according to the one or more access rights restrictions and adding the one or more users or user groups to the communication session when it is determined that the first user is authorized to add one or more users to the communication session and the one or more users or user groups are authorized to join the communication session. Other aspects can be embodied in corresponding systems and apparatus, including computer program products.

The operations may further include determining that at least one of the one or more users or user groups is restricted from joining the communication session according to at least one of the one or more access rights restrictions, determining if overwriting the at least one of the one or more access restrictions is allowed and adding the one or more users or user groups as participants of the communication session when it is determined that overwriting the at least one of the one or more access restrictions is allowed.

Additionally, the operations may include adding the one or more users or user groups other than the at least one of the one or more users or user groups restricted from joining the communication session to the communication session when it is determined that overwriting the at least one of the one or more access restrictions is not allowed. The operations may further include receiving a request from a first user to add one or more access right restrictions to the communication session, determining if the first user is authorized to add one or more restrictions to the communication session and associating the one or more access rights restrictions with the communication session when it is determined that the first user is authorized to add one or more access rights restrictions to the communication session.

The operations may additionally include receiving a request from a first user to invite a new user to the communication session, determining if the first user is authorized to invite users to the communication session, determining if the new user is authorized to join the session if it is determined that the first user is authorized to invite user to the communication session and inviting the new user to the communication session when it is determined that the first user is authorized to invite user to the communication session.

The disclosed subject matter also relates to a machine-readable medium including instructions stored therein, which when executed by a machine, cause the machine to perform operations including receiving a request to add one or more access rights restrictions to a communication session, wherein an access rights restriction associated with a communication session defines one or more operations authorized with respect to one or more users or user groups with respect to the communication session. The operations further including determining whether the communication session is associated with one or more existing access rights restrictions. The operations further including determining if the user is authorized to add the one or more access rights restrictions to the communication session according to the one or more existing access rights restrictions if the communication session is associated with one or more existing access rights restrictions and associating the one or more access rights restrictions with the communication session when it is determined that the user is authorized to add the one or more access rights restrictions to the communication session. Other aspects can be embodied in corresponding systems and apparatus, including computer program products.

The operations further include associating the one or more access rights restrictions with the session when it is determined that the communication session is not associated with one or more existing access rights restrictions. The operations may further include determining if the one or more access rights restrictions can be added to the existing one or more access rights restrictions if the communication session is associated with one or more existing access rights restrictions and associating the one or more access rights restrictions with the communication session when it is further determined that the one or more access rights restrictions can be added to the existing one or more access rights restrictions.

The operations may further include receiving a request from the user to invite a new user to the communication session, determining if the user is authorized to invite users to the communication session according to the one or more access rights restrictions associated with the communication session, determining if the new user is authorized to join the session according to the one or more access rights restrictions associated with the communication session if it is determined that the user is authorized to invite user to the communication session and inviting the new user to the communication session when it is determined that the new user is authorized to join the session.

These and other aspects described throughout the description facilitate controlling access in communication environments, such that users are able to communicate with one another in an access controlled environment.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for facilitating access control in a communication environment.

FIG. 2 illustrates a flow diagram of an example process for initiating a communication session.

FIG. 3 illustrates a flow diagram of an example process for adding access control restrictions to a communication session.

FIG. 4 illustrates a flow diagram of an example process for inviting one or more users to join a communication session.

FIG. 5 illustrates a flow diagram of an example process for allowing a user to join a session.

FIG. 6 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The subject disclosure provides a method and system for facilitating controlling access to one or more communication sessions within a communication environment. Users of a computer system may engage in a communication session through one or more web-based or offline applications and/or services (e.g., a social networking service, chat client or other similar service or application) at the user client device (e.g., through a web browser or an application installed at the user device).

As used herein, a “communication environment” refers to a computer-based environment, including a system or application, which facilitates communication and/or collaboration session between a group of users. A “communication session” (referred to herein more generally as a “session”) refers to a computer-based session including a group of people (participants) involved in a conversation, e.g., a video chat or conference. The conversation may be for various purposes including social or business objectives. In one example, the communication session is a collaboration session including a group of people performing a common task to achieve a common objective. During a communication session various objects may be shared among the participants for the purpose of conversation and/or collaboration. Shared objects may include files, documents, video, audio, images, tools, posts, and/or other data shared for the purpose of conversation and/or collaboration.

The entire communication environment and/or one or more communication sessions (e.g., all communication sessions initiated by a group of users belonging to a specific group or domain) may be associated with one or more access control lists. An access control list (ACL) is a list of permissions attached to one or more objects (e.g., the communication session(s)). An ACL specifies which users or system processes are granted access to objects, as well as what operations are allowed on given objects. Each entry in a typical ACL may specify a subject and an operation. The subject may be a specific user or a group of users. The group of users may be defined based on specific user properties including name, address, domain, demographic properties, geographic location, organizational properties, and other similar user properties and/or characteristics described in further detail below. In one example, user groups are dynamic such that users may be added or removed from a group (e.g., while the group definition remains the same). The ACL further includes operations with respect to a user or group, where the operations may include information regarding user access rights restrictions to join a communication session, to invite other users to a communication session, to remove other users from communication session, to edit objects shared within a communication session, to modify session restrictions regarding one or more communication sessions, to modify the ACL and/or other similar permissions for performing actions with respect to one or more communication sessions.

An entity may have a listing of users, and may create an ACL associated with the users for controlling user access and operations with respect to one or more communication sessions associated with the entity. The entity may include an organization being represented by a user and/or a user acting as the administrator for an entity, a user initiating one or more sessions, or other user having rights to place one or more restrictions on participants of a session and/or rights given to with respect to the session and/or objects shared within the session.

Access restrictions (e.g., listed within an ACL) may be associated with a group of communication sessions (e.g., a group of sessions defined by the entity). The group of communication sessions may be defined and/or identified based on various criteria including the user characteristics of the session initiator and/or participant(s), the specific client device at which the session is initiated and/or from which one or more users participate in, the specific domain associated with one or more users initiating and/or participating in the communication session, the location of the session initiator or participants including one or more of an IP address, network, and/or a geographic location, the topic(s) being discussed during the communication sessions, properties of objects being shared within a session (e.g., topic, author, object type, ownership, etc.), and/or context information of the communication session including time of day, number of participants, and participant attributes. In one example, access rights restrictions (e.g., listed within an ACL) generated for the group of communication sessions is associated with each individual session which meets the criteria defining the group. Access restrictions (e.g., listed within an ACL) may also be specified with respect to a specific session and may provide additional or alternative restrictions.

As described above, a communication session may be associated with more than one ACL or a single ACL having multiple levels of access control restrictions, where each ACL includes one or more access control restrictions with respect to sessions. Access control restrictions may be specified for each session by one or more users, for example, including users having a supervisory role with respect to the session (e.g., an administrator or other supervisor which may not necessarily participate in the session), a user initiating a session, and/or one or more users participating in the session. In one example, a user is capable of adding one or more access control restrictions with respect to a session or a group of sessions according to access rights associated with the user (e.g., within an ACL list of a group of sessions and/or other access rights associated with the user and/or sessions).

A first set of default access control restrictions may be assigned to a group of one or more sessions (e.g., by an administrator or supervisor of a business organization or entity for all communication sessions associated with the organization or entity). The group of sessions may be dynamically defined based on one or more criteria as described above. In one example the group of sessions is defined based on one or more criteria, rules and/or policies such that the group may dynamically change over time. The group may be defined by an administrator or other user having a supervisory role with respect to one or more communications sessions, and may be based on various attributes, including participant characteristics, context information (e.g., time or location) and other similar attributes. A specific session may also be associated with specific access control restrictions (e.g., by the session initiator or participants). In one example, one or more of the specific restrictions may overwrite one or more default restrictions which apply to a specific session.

The access control restrictions with respect to a session or a group of sessions (e.g., default or session specific restrictions), may include restrictions on users which can join a session or be invited to a session (e.g., based on various user characteristics) as well as access rights with respect to session operations including initiating a session, inviting other users to a session, adding restrictions to a session, editing restrictions regarding a session, editing objects shared within the session, commenting on the session or endorse the session, viewing posts relating to the session and other similar access rights regarding the session. The access rights restrictions may further include locations or client devices at which a session can be initiated or a user may participate in a session from, session duration or expiration, times of day where a session may be initiated or when participants may join or communicate through the session, limits on number of participants within each session and other similar restrictions.

Where a group of sessions is associated with default access control restrictions or existing access restrictions, the access control restrictions may further provide information regarding whether additional restrictions can be added to the communication session, whether the default access control restrictions can be overwritten and/or conditions for overwriting default access control restrictions (e.g., automatic or by request and approval from administrator, whether a warning message should be displayed and to whom, content and location of warning message, duration of warning message, etc.).

In one example, an entity being associated with a group of users (e.g., employees, members, etc.), or specific domains, client devices, brands, topics, objects may generate default access control restrictions with regard to one or more communication sessions. For example, an ACL including a listing of all employees of an organization, with respect to sessions initiated from a user belonging to a domain associated with or owned by an organization or other entity, or on a device owned by the entity, or with respect to objects, brands or topics solely owned by the entity and may provide access restrictions with regard to a group of sessions defined according to one or more criteria.

In one example, the access restrictions placed on users with regard to a session or a group of sessions may be defined per user or for a group of users or communication sessions. Thus, entries within an ACL may include specific user identification or a group. A group may be a pre-defined static group of users (e.g., a social group, an organizational group of other pre-defined group of people) or may be a dynamic rule-based group defined according to one or more criteria. In one example the group of users is defined based on one or more criteria, rules and/or policies such that the group may dynamically change over time. In one example, the ACL defines the users or types of users (e.g., defined according to one or more criteria) having access (or being prohibited from access) to one or more communication sessions and further defines one or more actions authorized with respect to each user or type of user having access to the one or more communication sessions. The criteria may for example include one or more user attributes including user domain, user IP address, user client device, user identifier, demographic information (e.g., age, gender, geographic location, income, occupation), user affiliation with various groups (e.g., sports teams, organizations, charities, causes, followers of specific profiles, etc.), geographic location and proximity (e.g., based on GPS, user check-in, or other indicators of user geographic location and proximity to a specified location), trust levels (e.g., user position at an organization), historical attributes associated with the user (e.g., based on user activity), user self-identification or system-identification attributes (e.g., users identifying themselves or the system identifying user as fans, followers, experts), and other similar user characteristics and attributes.

In one example, the system may suggest one or more access control restrictions to the user (e.g., when a user initiates a communication session, during a communication session and/or where the user defines a group of communication sessions). The suggestion of access control restrictions may be based upon communication session participants (e.g., when a participant is restricted or has previously been restricted for one or more past sessions, or based on some historical activity with respect to or on behalf of a participant), properties of the communication session (e.g., topic, participants, location, time, initiator, objects being shared, domain, device), where for example, similar communication sessions were previously restricted, keywords within the communication session including topic, content of communication, and other similar properties which may indicate that the communication session is likely a good candidate for various restrictions. Furthermore, the system may suggest specific restrictions based on restrictions historically placed on similar communication sessions.

Users of social networking services may create associations with one another. The phrase “social networking service” as used herein encompasses its plain and ordinary meaning, including, but not limited to, an online service, platform or site that focuses on building and reflecting of social associations among users. These associations may be stored within a social graph at each social networking service (e.g., maintained at remote server(s) 120). Such user associations may be defined on a user-to-user basis, or as a group of users associated through membership within a group. As used herein, “contacts” refer to other users that a user is associated with, at one or more social networking services.

A user may create “social groups” (e.g., social circles) including one or more contacts to organize his/her associations. The social groups may be additionally used to control distribution of messages and content to contacts of the user. For example, “social circles” are categories to which a user can assign their social networking contacts and better control the distribution and visibility of social networking messages as well as other multimedia content (e.g., documents, and other collaboration objects). In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social groups (e.g., social circles), the user can organize and categorize his/her contacts into various different groupings.

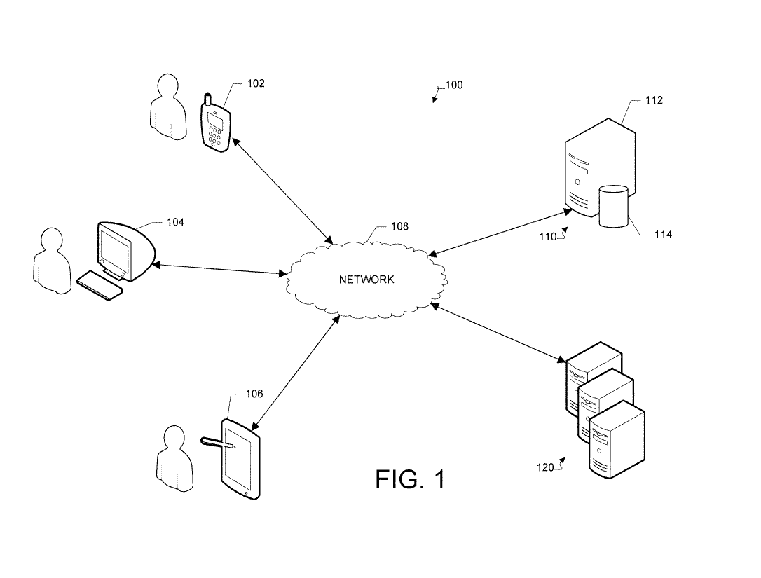

FIG. 1 illustrates an example client-server network environment, which provides for facilitating access control in a communication environment. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In some implementations, server 110 includes a processing device 112 and a data store 114. Processing device 112 executes computer instructions stored in data store 114, for example, to facilitate access in a communication environment associated with users interacting with electronic devices 102, 104, 106. Server 110 may further be in communication with remote servers 120 either through the network 108 or through another network or communication means.

According to some aspects, remote servers 120 can be any system or device having a processor, a memory and communications capability for hosting various remote social networking services. Remote servers 120 may be further capable of maintaining social graphs of users and their contacts. The remote social networking services hosted on the remote server 120 may enable users to create a profile and associate themselves with other users at a remote social networking service. The remote servers 120 may further facilitate the generation and maintenance of a social graph including the user created associations. The social graphs may include, for example, a list of all users of the remote social networking service and their associations with other users of a remote social networking service.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers. In one example, the system may be hosted at one or more social networking services (e.g., hosted at one or more servers 120) or may be a stand-alone application.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more social networking services hosted by remote servers 120, through a client application installed at the electronic devices 102, 104, 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

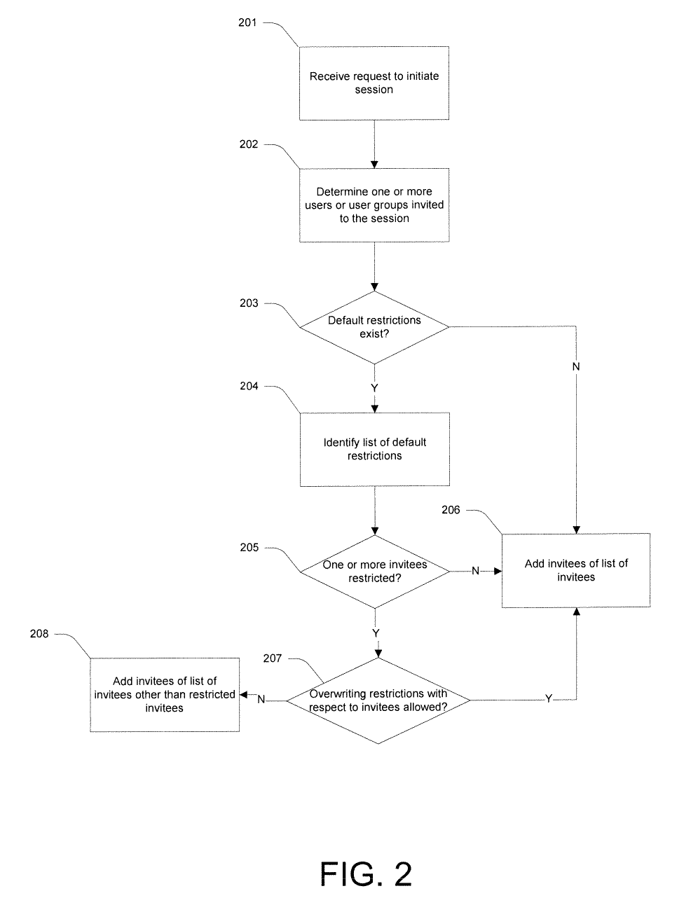

FIG. 2 illustrates a flow diagram of an example process 200 for initiating a communication session. In step 201, the system receives a request to initiate a communication session. In step 202, the system determines one or more users invited to the session (“invitees”). The invitees may be specified by the user, and may include one or more of the user's contacts and/or social groups associated with the user and including one or more users. The system, determines each user either specified individually or as a member of a group. Next, in step 203, the system determines if default access control restrictions are specified for the communication session. As described above, a group of communication sessions defined according to one or more properties may be associated with one or more default access restrictions (e.g., all communication sessions associated with an entity or a group of communication sessions defined according to one or more criteria).

If, in step 203, it is determined that default restrictions exist, the system identifies the list of default restrictions. In one example, the system may generate an ACL for a communication session, and may copy the default restrictions into the ACL. In another example, the system may access an existing ACL associated with a group of communication sessions including the communication session, which includes the default access control restrictions and may read the access control restrictions from the ACL. In step 205, the system determines if one or more invitees of the invitees determined in step 202 are restricted from joining the communication session according to the default restrictions (e.g., as included within the ACL). In one example, the system may provide one or more suggested alternative users to the user when it is determined that one or more invitees are restricted from joining the session. The suggestion may for example account for typos, pseudonyms, incorrect email address being entered or other similar errors that might have cause the user to enter the incorrect name.

If, in step 205, it is determined that one or more invitees are restricted from joining the session based on default access control restrictions, the system continues to step 207, and determines if overwriting default restrictions are allowed. In one example, default restrictions may include overwrite conditions. Overwrite conditions may not allow overwrite at all or may allow overwrite for one or more authorized users. In one example, the right to overwrite default restrictions may be included as access rights for a user within the ACL associated with a communication session. In one example, further conditions may be placed on overwriting default restrictions, where such overwriting is authorized. For example, the user setting default restrictions (e.g., an administrator or supervisor) may provide that default restrictions are only overwritten by an explicit request and/or warning to the administrator. Additionally, there may be a requirement to display a warning to the initiator and/or other participants of the session stating that default restrictions have been overwritten. In one example, only certain default restrictions may be overwritten (e.g., allowed invitees). In another example, the overwriting of default restrictions may be automatic for certain users not authorized based on default restrictions, may be allowed for another group by explicit authorization from an administrator, and/or may be prohibited for a group of users while allowed for other users.

If, in step 207, the system determines that overwriting default access control restrictions with respect to the one or more restricted invitees is not allowed, the process continues to step 208, and adds invitees other than restricted invitees to the session as participants.

On the other hand, if, in step 207, the system determined that overwriting default access control restrictions with respect to the one or more restricted invitees is allowed (e.g., based on automatic or explicit authorization), the process continues to step 206, and adds the invitees authorized to join the session to the session. Similarly, if, in step 205, it is determined that none of the invitees are restricted, or in step 203, it is determined that no default restrictions exist for the communication session, in step 206 the invitees are added to the session.

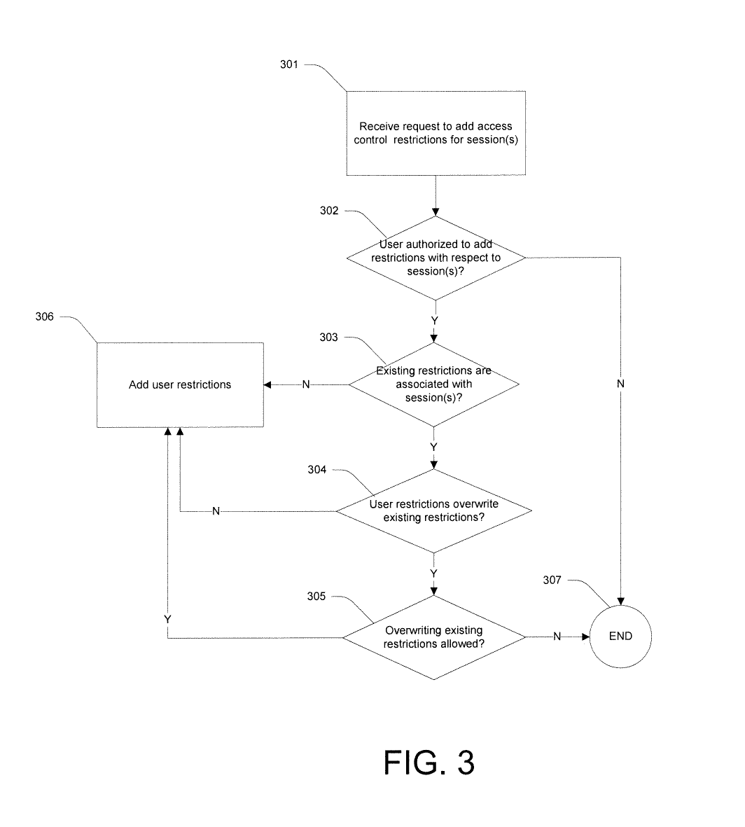

After the invitees of the list of invitees authorized to be invited to the session are added to the session, as participants in step 206 or 208, the system may send a link to each invitee allowing the invitees to join the session. The system may then create an ACL for the session and add the participants to the ACL for the session or may add the participants to an already existing ACL for the session (e.g., an ACL including the default restrictions associated with the session). The user initiating the session and or one or more participants may add one or more access restrictions to the session with respect to the participants of the session. The process for adding one or more access restrictions to the session is discussed in detail below with respect to FIG. 3.

FIG. 3 illustrates a flow diagram of an example process 300 for adding access control restrictions to a communication session. In step 301, the system receives a request to add access control restrictions for a session (or group of sessions). In one example, the request may be received from a user (e.g., an administrator or other user in a supervisory role) to associate access control restrictions with one or more sessions (e.g., a group of sessions). The administrator may provide one or more session properties and request to add access control restrictions (e.g., default restrictions) with respect to the one or more sessions. The request may also be received from a session participant (e.g., session initiator or other participant).

In step 302, the system determines if the user is authorized to add access control restrictions with respect to the one or more sessions. For example, the one or more sessions may be associated with one or more ACLs, including the user or some group of users including the user and may further include various authorized and/or prohibited operations with respect to the users. The system, may refer to the ACL(s) or some other rules associated with the one or more sessions (or similar sessions), and determine whether the user requesting the add access control restrictions with respect to the one or more sessions is authorized to do so.

If, the system determines, in step 302, that the user is authorized to add one or more access control restrictions with respect to the session, in step 303, it is determined if there are any existing restrictions with respect to the one or more sessions. For example, there may be default restrictions or pre-existing restrictions associated with the one or more sessions. In one example, the system may determine the properties associated with a group of sessions, as specified by a user, and may determine if the group of sessions is associated with one or more existing ACL(s). Similarly, if the request is with respect to a specific session, the system may determine if the specific session is associated with one or more ACLs.

If, in step 303, it is determined that existing restrictions are associated with the one or more sessions, the process continues to step 304. In step 304, the system determines if the access control restrictions specified by the user overwrite one or more existing restrictions associated with the one or more sessions. If so, in step 305, the system determines if the user is authorized to overwrite existing restrictions. For example, the existing restrictions may be specified with an ACL, including the user or some group of users including the user and may further include various authorized and/or prohibited operations with respect to the users. The system, may refer to the existing restrictions or some other rules associated with the one or more sessions (or similar sessions), and determine whether the user requesting to add access control restrictions with respect to the one or more sessions may overwrite existing access control restrictions.

If, in step 305, it is determined that the user is authorized to overwrite the existing restrictions, the process continues to step 306. In one example, a warning message may be provided to the user, when the user is overwriting one or more default restrictions, and the user may choose whether to proceed with overwriting default restrictions. Additionally, a notice may be issued to one or more users which indicated one or more of the existing restrictions or are otherwise associated with the one or more sessions (e.g., administrator or other supervisor), informing them that access control restrictions have been overwritten.

In one example, the right to overwrite existing restrictions may be included as access rights for a user within the ACL of a communication session. In one example, further conditions may be placed on overwriting existing restrictions, where such overwriting is authorized. For example, the user setting existing restrictions (e.g., an administrator or supervisor) may provide that existing restrictions are only overwritten by an explicit request and/or warning to the administrator. Additionally, there may be a requirement to display a warning to the initiator and/or other participants of the session stating that existing restrictions have been overwritten. In one example, only certain existing restrictions may be overwritten (e.g., allowed invitees). In another example, the overwriting of existing restrictions may be automatic for certain users not authorized based on existing restrictions, may be allowed for a group by explicit authorization from an administrator, or may be prohibited for a group of users while allowed for other users.

Similarly, if, in step 303, the system determines that no existing restrictions exist for the one or more sessions and/or in step 304, the system determines that the new access control restrictions do not overwrite any existing restrictions, the process continues to step 306. In step 306, the system associates the new access control restrictions with the one or more sessions. In one example, the system generates a new ACL and adds the access control restrictions to the ACL. In another example, the system may add the new restrictions to an existing ACL associated with the one or more sessions.

Alternatively, if the user is not authorized to add access control restrictions with respect to the one or more sessions, as determined in step 302, or to overwrite existing restrictions which the new restrictions overwrite, as determined in step 305, the process ends in step 307.

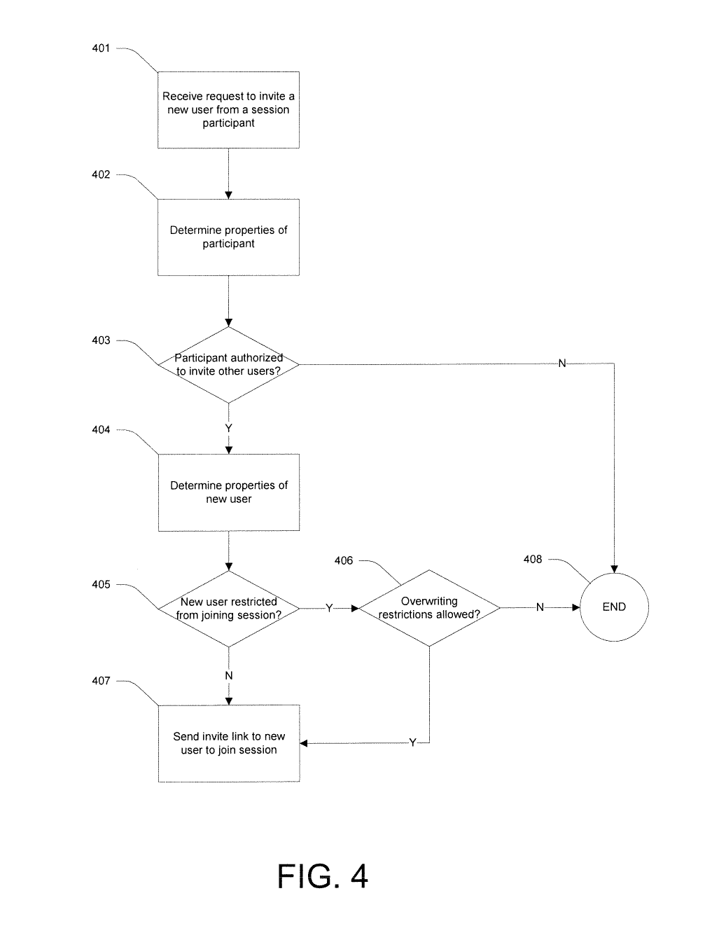

FIG. 4 illustrates a flow diagram of an example process 400 for inviting one or more users to join a communication session. In step 401, the system receives a request to invite a new user to a session from a session participant. While the process is discussed with respect to a participant it should be noted that similar steps may be performed with respect to another user not necessarily participating in the session but wishing to share the communication session with one or more other users who may be interested in the communication session.

In step 402, the system determines properties of the participant (or other user). The properties of the participant may include various user demographic, user identification, location (e.g., geographic, network or IP address), historical activity information with respect to the user, and other user characteristics accessible by the system (e.g., at a user profile for example at a social networking service).

In step 403, the system determines if the participant (or other user) is authorized to invite other users to the communication session (e.g., share the link to the communication session with other users), based on user properties determined in step 402. For example, the session may be associated with one or more ACLs, including the user or some group of users including the user and may further include various authorized and/or prohibited operations with respect to the user(s). The system, may refer to the ACL or some other rules associated with the session (or similar sessions), and determine whether the user is authorized to invite other users to the communication session.

If, in step 403, it is determined that the participant (or other user) is authorized to do so, in step 404, the system determines the properties of the new user. The properties of the new user may include similar user properties as those described above with respect to the participant (or other user) or may further include different or additional properties. In step 405, based on the user properties of the new user determined in step 404, the system determines if the new user is restricted from joining the session based on one or more access control restrictions associated with the session. For example, the system may look at one or more ACLs associated with the session to determine if the new user is restricted from joining the session. In one example, the system may provide one or more suggested alternative users to the user when it is determined that new user is restricted from joining the session. The suggestion may for example account for typos, pseudonyms, incorrect email address being entered or other similar errors that might have cause the user to enter the incorrect name.

If it is determined, in step 405, that the new user is restricted from joining the session, in step 406, the system determines if overwriting access control restrictions is authorized by the participant (or other user). In one example, the right to overwrite restrictions may be included as access rights for a user within the ACL of a communication session. In one example, further conditions may be placed on overwriting restrictions, where such overwriting is authorized. For example, the user setting restrictions (e.g., an administrator or supervisor) may provide that restrictions are only overwritten by an explicit request and/or warning to the administrator. Additionally, there may be a requirement to display a warning to the initiator and/or other participants of the session stating that restrictions have been overwritten. In one example, only certain restrictions may be overwritten (e.g., allowed invitees), in another example, the overwriting of restrictions may be automatic for certain users not authorized based on restrictions, may be allowed for a group by explicit authorization from an administrator, or may be prohibited for a group of users while allowed for other users.

If the new user is not restricted from joining the session, as determined in step 402, or if overwriting restrictions is authorized, as determined in step 406, the process continues to step 407. In step 407, the system sends the new user a link to the session or otherwise notifies the user of the session and the ability of the new user to join the session. Otherwise, if in step 405, it is determined that the participant (or other user) is not authorized to invite other users to the session, as determined in step 403, or to overwrite access control restrictions prohibiting the new user from joining the session, as determined in step 406, the process ends in step 408.

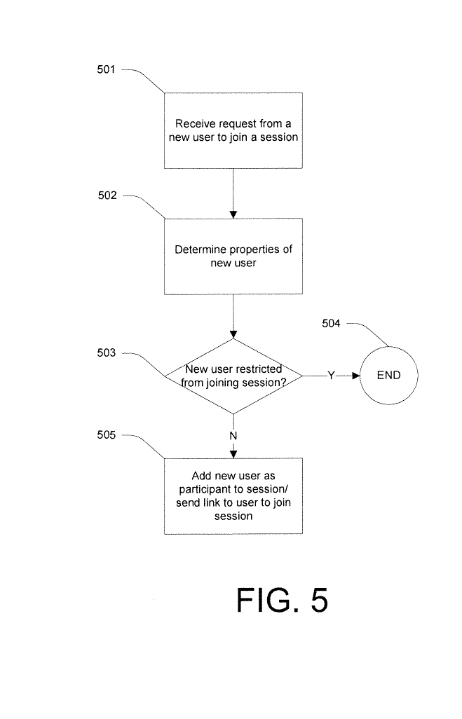

FIG. 5 illustrates a flow diagram of an example process 500 for allowing a user to join a session. In step 501, the system receives a request from a new user to join a session. In step 502, the system determines one or more properties of the new user (e.g., similar to step 404 of process 400). In step 503, the system determines if the user is restricted from joining the session (e.g., similar to step 405 of process 400). If, it is determined that the user is restricted from joining the session, in step 503, the process ends in step 504. The user may be presented with a message alerting the user that the user is not authorized to join the session. In one example, the user may further be provided with instructions on how to seek authorization.

Otherwise, if, in step 503, it is determined that the user is authorized to join the session, in step 505, the system adds the user to the participants of the new session. In one example, where a user is added to the participants of a session, various access rights may be associated with the user (e.g., where user properties of the user place the user within a group specified as having access right restrictions and/or when general access right restrictions apply to all users participating in the session, which may itself be defined as a user group).

FIGS. 2-5 describe processes for allowing a user to perform various actions with respect to one or more sessions. One or more of the above steps described with respect to these processes may be performed when a user requests to perform various other actions within a communication environment and/or with respect to one or more communication session. Such activity may include removing a user from a session, removing restrictions from a session, or otherwise editing restrictions associated with the session, sharing objects within a session, editing objects within a session, or other similar actions which may be performed with respect to a session and for which various access right restrictions may be specified (e.g., within one or more ACLs associated with a session).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

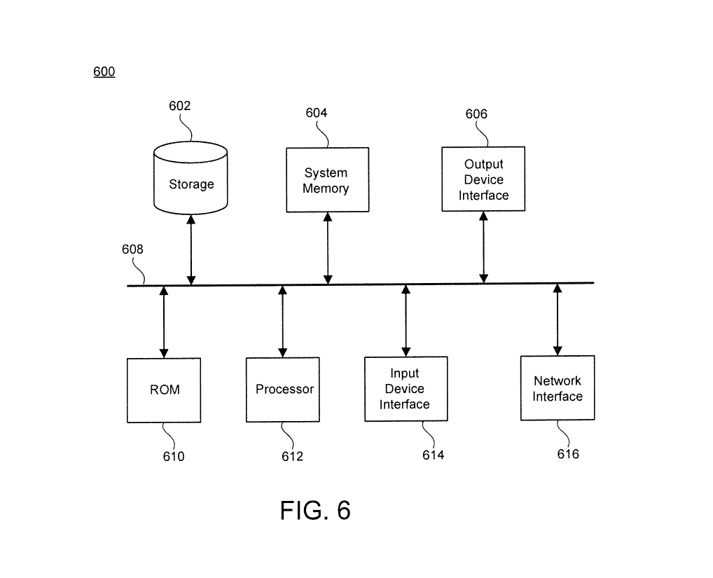

FIG. 6 conceptually illustrates an electronic system with which some implementations of the subject technology are implemented. Electronic system 600 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for managing communication sessions according to various implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method, comprising:
receiving a request from a user to add one or more users or user groups to a communication session;
determining if one or more access rights restrictions are associated with the session, wherein the one or more access rights restrictions define one or more users or one or more types of users authorized to join the communication session;
determining if the one or more users or user groups are authorized to join the communication session according to the access rights restrictions, when it is determined that one or more access rights restrictions are associated with the communication session; and
adding the one or more users or user groups to the communication session when it is determined that the one or more users or user groups are authorized to join the communication session.

2. The method of claim 1, wherein the one or more access rights restrictions further define one or more operations authorized with respect to each of the one or more users or user groups.

3. The method of claim 1, further comprising:
determining that at least one of the one or more users or user groups is restricted from joining the communication session according to at least one of the one or more access rights restrictions;
determining if overwriting the at least one of the one or more access restrictions is allowed; and
adding the one or more users or user groups as participants of the communication session when it is determined that overwriting the at least one of the one or more access restrictions is allowed.

4. The method of claim 3, further comprising:
adding the one or more users or user groups other than the at least one of the one or more users or user groups restricted from joining the communication session to the communication session when it is determined that overwriting the at least one of the one or more access restrictions is not allowed.

5. The method of claim 1, further comprising:
receiving a request from a first user to add one or more access right restrictions to the communication session;
determining if the first user is authorized to add one or more restrictions to the communication session; and
associating the one or more access rights restrictions with the communication session when it is determined that the first user is authorized to add one or more access rights restrictions to the communication session.

6. The method of claim 1, further comprising:
receiving a request from a first user to invite a new user to the communication session;
determining if the first user is authorized to invite users to the communication session;
determining if the new user is authorized to join the session if it is determined that the first user is authorized to invite user to the communication session; and
inviting the new user to the communication session when it is determined that the first user is authorized to invite user to the communication session.

7. The method of claim 1, wherein the one or more access rights restrictions comprise one or more access rights restrictions assigned to a one or more communication sessions including the communication session.

8. The method of claim 6, wherein the one or more communication sessions are defined based on one or more attributes, and wherein the attributes of the communication session match the one or more attributes defining the one or more communication sessions.

9. The method of claim 7, wherein the one or more attributes comprise one or more of context information, session attributes, or participant attributes.

10. The method of claim 7, wherein the context information comprises one or more of a location where the communication session is initiated, a location from which one or more of the users participate in the communication session, a time when the communication session is initiated or a time where the request is received.

11. The method of claim 1, wherein the one or more groups of users are defined based on one or more attributes, the attributes including one or more of user attributes, context information or communication session attributes.

12. A system comprising:
one or more processors; and
a machine-readable medium comprising instructions stored therein, which when executed by the processors, cause the processors to perform operations comprising:
receiving a request to add one or more users or user groups to a communication session from a first user;
identifying one or more access rights restrictions corresponding to the communication session, wherein the one or more access rights restrictions comprise a list of one or more users or user groups authorized to join the session and one or more operations authorized with respect to each of the one or more users or user groups;
determining if the first user is authorized to add one or more users to the communication session according to the one or more access rights restrictions; and
determining if the one or more users or user groups are authorized to join the communication session according to the one or more access rights restrictions; and
adding the one or more users or user groups to the communication session when it is determined that the first user is authorized to add one or more users to the communication session and the one or more users or user groups are authorized to join the communication session.

13. The system of claim 12, the operations further comprising:
determining that at least one of the one or more users or user groups is restricted from joining the communication session according to at least one of the one or more access rights restrictions;
determining if overwriting the at least one of the one or more access restrictions is allowed; and
adding the one or more users or user groups as participants of the communication session when it is determined that overwriting the at least one of the one or more access restrictions is allowed.

14. The system of claim 13, the operations further comprising:
adding the one or more users or user groups other than the at least one of the one or more users or user groups restricted from joining the communication session to the communication session when it is determined that overwriting the at least one of the one or more access restrictions is not allowed.

15. The system of claim 12, the operations further comprising:
receiving a request from a first user to add one or more access right restrictions to the communication session;
determining if the first user is authorized to add one or more restrictions to the communication session; and
associating the one or more access rights restrictions with the communication session when it is determined that the first user is authorized to add one or more access rights restrictions to the communication session.

16. The system of claim 12, the operations further comprising:
receiving a request from a first user to invite a new user to the communication session;
determining if the first user is authorized to invite users to the communication session;
determining if the new user is authorized to join the session if it is determined that the first user is authorized to invite user to the communication session; and
inviting the new user to the communication session when it is determined that the first user is authorized to invite user to the communication session.

17. A machine-readable medium comprising instructions stored therein, which when executed by a machine, cause the machine to perform operations comprising:
receiving a request to add one or more access rights restrictions to a communication session, wherein an access rights restriction associated with a communication session defines one or more operations authorized with respect to one or more users or user groups with respect to the communication session;
determining whether the communication session is associated with one or more existing access rights restrictions;
determining if the user is authorized to add the one or more access rights restrictions to the communication session according to the one or more existing access rights restrictions if the communication session is associated with one or more existing access rights restrictions; and
associating the one or more access rights restrictions with the communication session when it is determined that the user is authorized to add the one or more access rights restrictions to the communication session.

18. The machine readable medium of claim 17, the operations further comprising:
associating the one or more access rights restrictions with the session when it is determined that the communication session is not associated with one or more existing access rights restrictions.

19. The machine-readable medium of claim 17, the operations further comprising:
determining if the one or more access rights restrictions can be added to the existing one or more access rights restrictions if the communication session is associated with one or more existing access rights restrictions; and
associating the one or more access rights restrictions with the communication session when it is further determined that the one or more access rights restrictions can be added to the existing one or more access rights restrictions

20. The machine-readable medium of claim 17, the operations further comprising:
receiving a request from the user to invite a new user to the communication session;
determining if the user is authorized to invite users to the communication session according to the one or more access rights restrictions associated with the communication session;
determining if the new user is authorized to join the session according to the one or more access rights restrictions associated with the communication session if it is determined that the user is authorized to invite user to the communication session; and
inviting the new user to the communication session when it is determined that the new user is authorized to join the session.
